(19) United States
(12) Patent Application Publication
(10) Pub. No.: US 2026/0356293 A1
(43) Pub. Date: Nov. 12, 2026

(54) METHOD FOR ALIGNING A VEHICLE REARVIEW MIRROR AND EGO VEHICLE HAVING A VEHICLE REARVIEW MIRROR

(71) Applicant: Ford Global Technologies, LLC, Dearborn, MI (US)

(72) Inventors: Paul Jamnicki, Bonn (DE); Elena Feichtenbeiner, Rösrath (DE)

(73) Assignee: Ford Global Technologies, LLC, Dearborn, MI (US)

(21) Appl. No.: 19/643,475

(22) Filed: Apr. 9, 2026

(30) Foreign Application Priority Data
Apr. 30, 2025 (DE) 102025116624.2

(51) Int. Cl. B60R 1/28; B60R 1/04; B60R 1/062; B60R 1/12

(52) U.S. Cl. CPC B60R 1/28; B60R 1/04; B60R 1/062; B60R 1/12; B60R 2001/1223; B60R 2300/10; B60R 2300/80

(57) ABSTRACT

A method is provided for aligning a vehicle rearview mirror to reduce dazzling of a driver of an ego vehicle. The method includes registering surroundings of the ego vehicle to determine positions of foreign vehicles and determining whether a foreign vehicle is located within a predetermined dazzle area. A position of a head of the driver and a current setting of the vehicle rearview mirror are registered. Based on the determined position of the foreign vehicle, the mirror setting, and the head position of the driver, it is determined whether light emitted from the foreign vehicle is capable of dazzling the driver. When dazzling is determined, the vehicle rearview mirror is adjusted from a base position to an adjustment position, or from a current adjustment position to a further adjustment position, to reduce dazzling of the driver.

### CROSS-REFERENCE TO RELATED APPLICATIONS

The present application claims priority to and the benefit of German Application No. 102025116624.2, filed Apr. 30, 2025, which is hereby incorporated by reference herein in its entirety.

### FIELD

The disclosure relates to a method for aligning a vehicle rearview mirror to reduce dazzling of a driver of an ego vehicle. The disclosure also relates to an ego vehicle having a vehicle rearview mirror.

### SUMMARY

Vehicle rearview mirrors are arranged according to regulations on motor vehicles in order to enable a driver of the motor vehicle to have a clear view of the traffic behind the ego motor vehicle. This is important in particular during driving maneuvers such as a lane change or during reverse driving and parking with the motor vehicle.

A driver of the ego vehicle can be dazzled, for example, in the case of darkness or a corresponding light sensitivity of the driver by light from headlights of a following vehicle, in this description referred to as a foreign vehicle, if the light is reflected by a vehicle rearview mirror in the field of view of the driver of the ego vehicle and reaches his eyes. The vision of the driver of the ego vehicle can thus be impaired for a short time during and after the occurrence of the dazzling, which is undesirable when driving motor vehicles, since the driver can be temporarily impaired in his visual capacity or is at least distracted in this way.

To avoid such dazzle effects, using a so-called dazzle-free rearview mirror at least in the vehicle interior is known. Such a dazzle-free rearview mirror can prevent a driving activity of a driver of the ego vehicle from being obstructed by a dazzle effect from headlights of a following foreign vehicle.

Dazzle-free rearview mirrors can also be used as vehicle rearview mirrors arranged on the outside of the motor vehicle, which results in higher costs of such vehicle rearview mirrors. In particular because the vehicle rearview mirrors arranged on the outside of the motor vehicle can easily be damaged or destroyed in the event of accidents, such higher costs or repair costs are undesired.

Vehicle rearview mirrors arranged on the outside of the motor vehicle typically have an associated electrically operated mirror adjustment device, by means of which the driver can change the alignment of the vehicle rearview mirror, in particular the mirror glass in the vehicle rearview mirror, by means of a control element arranged in the vehicle interior. By operating the control element, the driver can align the mirror glass in the vehicle rearview mirror such that the driver has an optimum view to the rear. An adjustment of the alignment of the vehicle rearview mirror arranged on the outside of the vehicle to the respective driver is performed in this way. Using the mirror adjustment device, the driver moves the vehicle rearview mirror arranged on the outside of the vehicle into its respective, so-called base position before beginning a journey, in which the vehicle rearview mirrors enable an optimum view to the rear for the driver. Such a mirror adjustment device can also provide data or angle values with respect to a current position or alignment of the vehicle rearview mirror, in particular the mirror glass in the vehicle rearview mirror. Such angle values indicate a deviation of the mirror glass in the vehicle rearview mirror from a vertical line and a deviation of the mirror glass in the vehicle rearview mirror from a transverse direction of the vehicle rearview mirror of the vehicle. In particular, such deviations are indicated by values of the associated angles.

Also, before beginning a journey, the driver of the motor vehicle also moves the interior vehicle rearview mirror arranged in the inside of the vehicle into its base position, in which the interior vehicle rearview mirror also enables an optimum view to the rear for the driver.

The vehicle rearview mirrors arranged on the outside of the vehicle and the interior vehicle rearview mirrors typically remain in their respective base positions which have been set once during the journey with the motor vehicle.

A set base position of a vehicle rearview mirror has the disadvantage that, for example, light from a headlight of a following vehicle, thus a foreign vehicle, is reflected by the vehicle rearview mirror located in its base position into the field of view of the driver of the ego vehicle and in particular into his eyes and the driver is impaired by such a dazzle effect in his ability to guide the motor vehicle. In special cases, dazzling of the driver can also take place via multiple vehicle rearview mirrors.

Therefore, various attempts to reduce such dazzle effects are known from the prior art.

DE 11 2017 004 176 T5 discloses a vehicle rearview mirror device which contains a housing, a one-way mirror, and an angle adjustment device having a camshaft, a stationary part, and a drive part. When the camshaft is rotated by a drive force transmitted from the drive part and moves due to the action of a cam toward the stationary part, a movable part tilts as a whole, comprising the housing, the one-way mirror, and the drive part. The drive part contains a drive source and a transmission, which transmits the drive force of the drive source to the camshaft. The transmission contains a first gear wheel, arranged on the camshaft, and a second gear wheel, which is elastically engaged with the first gear wheel.

DE 11 2006 002 070 B4 describes a method for positioning a driver side mirror and optionally also a passenger side mirror of a vehicle. A command for switching into the other of a blind spot mirror position or a blind spot/dimmed mirror position is detected. It is provided in this case that a current angle of the driver side mirror is determined, wherein it is ascertained on the basis of the angle whether the driver side mirror is in the blind spot mirror position or the blind spot/dimmed mirror position. In response to the command, the driver side mirror and optionally also the passenger side mirror is moved into the other of the blind spot mirror position or the blind spot/dimmed mirror position.

This known prior art has the disadvantage that the known solutions are costly and complex. In addition an activity of the driver himself is usually necessary to trigger a change on a vehicle rearview mirror.

In view of these statements, there is still room for improvement in conjunction with the disclosed prior art in the area of methods for aligning a vehicle rearview mirror to reduce dazzling of a driver of a motor vehicle and in ego vehicles having vehicle rearview mirrors. In particular, dazzling of the driver of a leading vehicle by a light source of a following vehicle is to be avoided when the latter is located in a dazzling area, which is located in particular behind the leading vehicle.

The disclosure is based on the object of disclosing a method for aligning a vehicle rearview mirror to reduce dazzling of a driver of an ego vehicle and an ego vehicle having vehicle rearview mirrors, by which an automated change on a vehicle rearview mirror is implemented in order to reduce dazzling of a driver of an ego vehicle and thus to relieve the driver when guiding the ego vehicle.

The part of the object relating to the method is achieved according to the disclosure by a method for aligning a vehicle rearview mirror to reduce dazzling of an ego vehicle having the features of claim 1.

A method is disclosed for aligning a vehicle rearview mirror to reduce dazzling of a driver of an ego vehicle, wherein the vehicle rearview mirror of the ego vehicle is aligned at the beginning of a journey in a base position, comprising at least the following steps:
registering the surroundings of the ego vehicle, wherein positions of foreign vehicles located in the surroundings of the ego vehicle are determined,
ascertaining whether a determined position of a foreign vehicle is in a predetermined dazzle area,
registering a position of the head of the driver in the ego vehicle and a current setting of the vehicle rearview mirror of the ego vehicle,
initially checking whether a light beam of a light source of the foreign vehicle located in the dazzle area can dazzle the driver of the ego vehicle,
changing the current setting of the vehicle rearview mirror from the base position to an adjustment position deviating from the base position or from a current adjustment position into a further adjustment position to reduce the dazzling of the driver by the light beam of the foreign vehicle.

Advantageous designs are disclosed in the dependent claims.

It should be noted that the features and measures specified individually in the following description can be combined with one another in any desired technically meaningful way and disclose further embodiments of the disclosure. The description additionally characterizes and specifies the disclosure, in particular in conjunction with the figures.

Due to the method, at least one vehicle rearview mirror arranged on the outside of an ego vehicle, which can also be referred to here as an ego motor vehicle, and/or an interior vehicle rearview mirror arranged in an interior of the ego vehicle is influenced or aligned such that dazzling of the driver of the ego vehicle is eliminated or at least reduced. It is provided in particular in this case that a mirror glass arranged in the vehicle rearview mirror or in the interior vehicle rearview mirror is aligned such that dazzling of the driver of the ego vehicle is eliminated or at least reduced.

Such vehicle rearview mirrors arranged on the outside of a typical motor vehicle are typically arranged on the driver side and on the passenger side of the motor vehicle and are also referred to as the driver side rearview mirror and passenger side rearview mirror.

The disclosure provides a method for aligning a mirror glass arranged in the vehicle rearview mirror to reduce dazzling of a driver of an ego vehicle, wherein at least one vehicle rearview mirror influenced according to the method is arranged on an ego vehicle or ego motor vehicle.

The term “motor vehicle” in the narrower sense refers here to a road vehicle, thus a vehicle suitable and authorized for road traffic having its own drive motor. The drive motor can be an internal combustion engine or an electric drive motor, a combination in the form of a hybrid drive is also conceivable. In particular, it can be a passenger vehicle, a truck, or a bus. The motor vehicle preferably has at least two axles each having two wheels, however, deviations therefrom are also conceivable. The motor vehicle can be controllable by a driver at least sometimes. However, it can also be configured to travel autonomously at least sometimes, thus without control by the driver. The motor vehicle is also referred to hereinafter as a “vehicle” for the sake of brevity.

For simplification, the word group “alignment of a vehicle rearview mirror” is sometimes used, although it is clear to a person skilled in the art that this means in particular an alignment of a mirror glass arranged in the vehicle rearview mirror.

The disclosure advantageously effectively prevents dazzling of the driver of a leading vehicle, referred to here as the ego vehicle, by a light source of the following vehicle, referred to here as the foreign vehicle. Therefore, no or at least only reduced dazzling of the driver of the ego vehicle occurs. Significantly less distraction or confusion of the driver of the ego vehicle is connected therewith. Even a temporary impairment of the vision of the driver of the ego vehicle due to dazzling by a light source of the foreign vehicle, in particular due to dazzling by a light beam of a light source such as a headlight of the following foreign vehicle, is prevented.

It is preferably provided that in a first method step, the surroundings of the ego vehicle are registered, wherein positions of foreign vehicles located in the surroundings of the motor vehicle are determined.

For example, other vehicles or foreign vehicles are detected in an area of 1 m to 50 m around the ego vehicle. This detection of the foreign vehicles takes place both during the journey of the ego vehicle and also during a stop at a traffic signal or intersection. A general situation picture results in this way, which contains the determined positions of the foreign vehicles with their current coordinates in a relative relationship to the ego vehicle. This situation picture can also contain speeds and travel directions of the detected foreign vehicles.

It is furthermore provided that in a second method step, it is ascertained whether a determined position of a foreign vehicle is in a predetermined dazzle area.

A dazzle area is defined as an area which is located in particular behind and at least partially adjacent to the ego vehicle. This dazzle area is definable within the meaning of the disclosure in that a light beam of a light source of a foreign vehicle located in the dazzle area, reflected via a vehicle rearview mirror, can reach the driver of the ego vehicle, dazzle him, and disturb his concentration on guiding the ego vehicle. In this case, the light beam of the light source can be reflected via one or more vehicle rearview mirrors arranged on the ego vehicle toward the driver. Such a dazzle area can have, for example, the form of a lobe or circular sector and is aligned toward the rear or opposite to the travel direction of the ego vehicle.

The positions of the foreign vehicles determined in the first method step are advantageously checked as to whether their coordinates are located in the defined dazzle area. At the end of the second method step, all foreign vehicles are ascertained which are currently located in the predetermined dazzle area and could therefore be potentially capable of dazzling the driver of the ego vehicle with their light sources.

For the case that it is established at the end of the second method step that no foreign vehicle is currently located in the dazzle area, it is provided in a preferred variant of the method for aligning a vehicle rearview mirror that the method returns to the first method step and the base position of the vehicle rearview mirror is maintained. The vehicle rearview mirror therefore remains in the base position set at the beginning of the journey.

For the case that the setting of the vehicle rearview mirror has already been changed according to the method, for example, in a fifth method step which will be described in more detail hereinafter, from its base position to an adjustment position, it is provided that the vehicle rearview mirror is moved from the current adjustment position back into the base position, since there is no risk of potential dazzling for the driver.

In this description, the concept of potential dazzling for the driver is used. This means a possible or expectable dazzling of the driver of the ego vehicle, since such dazzling of the driver does not have to occur in each individual case. For example, it is possible due to an incorrect alignment of a headlight of a foreign vehicle or unpredictable driving manoeuvres of the foreign vehicle that no dazzling of the driver of the ego vehicle takes place although the foreign vehicle is in the defined dazzle area. The described method already causes, in the event of the possibility of potential dazzling for the driver of the ego vehicle and also for reasons of comfort, a change of the current setting of the vehicle rearview mirror into an adjustment position deviating from the base position. Since such a change of the current setting of the vehicle rearview mirror only takes place in a limited range due to the described method, thus only up to a defined maximum resulting angle amount, it is possible for the driver of the ego vehicle at any time to achieve a view to the rear again, into the area behind the motor vehicle, by a minor change of the position of the head of the driver of the ego vehicle, for example, to the rear or to the side. The driving comfort is therefore ensured according to the method at all times, even in a maximum adjustment position of the vehicle rearview mirror.

In a third method step following the second method step, a position of the head of the driver in the ego vehicle is registered and a current setting of the vehicle rearview mirror of the ego vehicle takes place.

To prepare for the following fourth method step, in the third method step, the current position of the head of the driver in the ego vehicle is determined or ascertained. This is necessary because not all possible drivers of the ego vehicle have a comparable anatomy and typically they do not prefer the same settings, for example, of the height and/or inclination of a vehicle seat in the ego vehicle. It is known that, for example, different heights of drivers result in different setting angles and therefore different base positions of the mirror glass in the vehicle rearview mirror. These differences are taken into consideration by the ascertainment of the current position of the head of the driver in the ego vehicle.

Furthermore, the current setting of the vehicle rearview mirror of the ego vehicle, in particular the mirror glass in the vehicle rearview mirror, is registered. The mirror glass, which is arranged to be movable in the vehicle rearview mirror, will be changed in its position in the vehicle rearview mirror by means of a mirror adjustment device, for example. The driver of the ego vehicle can therefore bring the corresponding mirror glass in the vehicle rearview mirror into its base position, in which the driver has an optimum view to the rear.

The alignment or current setting of the mirror glass in the vehicle rearview mirror is specified, for example, by means of two angles or angle values. A first angle is an angle of inclination, also called a pitch angle, which specifies a deviation of the alignment of the mirror glass in the vehicle rearview mirror from a transverse axis of the ego vehicle. In this case, the transverse axis of the motor vehicle is orthogonal to a longitudinal axis of the ego vehicle, which is aligned in a travel direction of the ego vehicle. A second angle is a yaw angle in relation to a vertical line, which is aligned perpendicularly to the Earth's surface or roadway. The yaw angle therefore specifies a deviation of the alignment of the mirror glass in the vehicle rearview mirror from the vertical line.

In the registration of the current setting of the mirror glass in the vehicle rearview mirror, the values for the yaw angle and angle of inclination can be provided by the mirror adjustment device or ascertained by means of corresponding sensors in the vehicle rearview mirror.

In the fourth method step, it is preferably provided that a first check takes place such that it is established whether a light beam of a light source of the foreign vehicle located in the dazzle area can dazzle the driver of the ego vehicle.

At the end of the third method step, for example, information on a position of a foreign vehicle in the dazzle area, a position of the head of the driver in the ego vehicle, and the current setting of the vehicle rearview mirror of the ego vehicle with associated yaw angle and angle of inclination is known.

Under a general presumption that headlights in a motor vehicle are typically arranged in pairs and in the outer areas of the vehicle front body, it is possible to ascertain in a first check whether a light beam of a light source such as a headlight of the foreign vehicle, which is currently located in the dazzle area, reflected by the mirror glass in the vehicle rearview mirror, can reach the head of the driver of the ego vehicle and therefore his eyes and can therefore potentially dazzle the driver.

If it is established in this first check that dazzling of the driver of the ego vehicle is not probable and the vehicle rearview mirror, in particular the mirror glass in the vehicle rearview mirror, is in the base position, no change of the current setting of the vehicle rearview mirror is performed. The method is then continued in the first method step.

For the alternative case, that it is established in this first check that dazzling of the driver of the ego vehicle is not probable and the vehicle rearview mirror, in particular the mirror glass in the vehicle rearview mirror, is already in an adjustment position, the vehicle rearview mirror is transferred from this adjustment position back into its base position again. The method is then continued in the first method step.

If it is established in this first check that dazzling of the driver of the ego vehicle is probable, in the following fifth method step, a change of the current setting of the vehicle rearview mirror of the ego vehicle, in particular the mirror glass in the vehicle rearview mirror, is performed. Such a change of the current setting of the vehicle rearview mirror can be an adjustment from the base position into an adjustment position or an adjustment from a current first adjustment position into a further second adjustment position. According to the disclosure, such a change of the current setting of the vehicle rearview mirror can affect the yaw angle of the mirror glass or the angle of inclination of the mirror glass or the yaw angle and the angle of inclination.

In one example, in which the vehicle rearview mirror is in the base position, a yaw angle in a current base position is greater or less than a yaw angle in a first adjustment position, into which the vehicle rearview mirror is moved in the fifth method step. In one preferred variant, the yaw angle of the base position is greater than the yaw angle of the first adjustment position. In this case, the mirror glass in the vehicle rearview mirror is pivoted away outward in order to reduce the dazzling of the driver of the ego vehicle. If the driver of the ego vehicle nonetheless wishes to achieve a view to the rear in this first adjustment position of the vehicle rearview mirror, he could move his head to the rear, thus opposite to the travel direction, in order to compensate for the adjustment procedure performed on the vehicle rearview mirror.

In a second example, in which the vehicle rearview mirror is in the base position, an angle of inclination in relation to a vertical line in the current base position is greater or less than an angle of inclination in a first adjustment position, into which the vehicle rearview mirror is moved in the fifth method step. In one preferred variant, the angle of inclination in the base position is less than the angle of inclination in the first adjustment position. In this case, the mirror glass in the vehicle rearview mirror is pivoted away forward in order to reduce the dazzling of the driver of the ego vehicle. If the driver of the ego vehicle nonetheless wishes to achieve a view to the rear in this first adjustment position of the vehicle rearview mirror, he could move his head forward, thus in the travel direction, and/or upward in order to compensate for the adjustment procedure performed on the vehicle rearview mirror.

In one example, in which the vehicle rearview mirror is already in a first adjustment position, a yaw angle in a current first adjustment position is greater or less than a yaw angle in the further second adjustment position. In one preferred variant, the yaw angle of the current first adjustment position is greater than the yaw angle of the further second adjustment position. In this case, the mirror glass in the vehicle rearview mirror is pivoted away outward in order to reduce the dazzling of the driver of the ego vehicle. If the driver nonetheless wishes to achieve a view to the rear in this further adjustment position of the vehicle rearview mirror, he could move his head to the rear, thus opposite to the travel direction, in order to compensate for the adjustment procedure performed on the vehicle rearview mirror.

In a second example, in which the vehicle rearview mirror is already in a first adjustment position, an angle of inclination in relation to a vertical line in the current first adjustment position is greater or less than an angle of inclination of the further second adjustment position. In one preferred variant, the angle of inclination of the current first adjustment position is less than the angle of inclination of the further second adjustment position. In this case, the mirror glass in the vehicle rearview mirror is pivoted away forward in order to reduce the dazzling of the driver of the ego vehicle. If the driver of the ego vehicle nonetheless wishes to achieve a view to the rear in this further adjustment position of the vehicle rearview mirror, he could move his head forward, thus in the travel direction, or upward, in order to compensate for the adjustment procedure performed on the vehicle rearview mirror.

After a change of the current setting of the vehicle rearview mirror of the ego vehicle has taken place in the fifth method step in order to reduce dazzling of the driver by the light beam of the foreign vehicle, the method sequence is continued in the first method step with the next pass.

In one option of the present method, it is provided that after the change of the current setting of the vehicle rearview mirror in the fifth method step, a second check takes place as to whether the driver is currently still being dazzled by the light beam of the foreign vehicle and for the case that the dazzling still exists, a further change of the current setting of the vehicle rearview mirror from the current adjustment position into a further adjustment position having a greater deviation from the base position takes place until current dazzling is no longer established in the second check.

A single adjustment step, in which the vehicle rearview mirror of the ego vehicle is adjusted from the base position into a first adjustment position deviating from the base position or from a current adjustment position into a further adjustment position by a defined angle amount is possibly not sufficient to adequately reduce the dazzling of the driver by the light beam of the foreign vehicle. It is therefore provided that multiple adjustments are carried out in succession until the driver of the ego vehicle is no longer dazzled or is no longer significantly dazzled by the light beam of the foreign vehicle. Such adjustment steps can change, for example, the yaw angle and/or the angle of inclination by an angle amount of 0.5° or 1.0°. In one example, in which an adjustment step for the yaw angle has an angle amount of 0.5°, a resulting angle amount of the yaw angle after three successive adjustment steps is 1.5° in order to effectively reduce the dazzling of the driver by the light beam of the foreign vehicle. After this optional method step, the method sequence is continued in the first method step with the next pass.

Upon the change of the current setting of the vehicle rearview mirror of the ego vehicle, it is always ensured according to the method that a maximum resulting angle amount between the base position of the vehicle rearview mirror and a maximum adjustment position of the vehicle rearview mirror is in a range between 3° and 20°. This limiting of the maximum resulting angle amount ensures that a view of the driver of the ego vehicle to the rear is ensured even in the maximum adjustment position of the vehicle rearview mirror. In order to achieve the view of the driver of the ego vehicle to the rear, the driver only has to change the position of his head in a reasonable range even at a maximum adjustment position of the vehicle rearview mirror. Such a change of the position of the head of the driver of the ego vehicle is, for example, a movement of the head to the rear or forward and/or upward, wherein the driver essentially maintains his position in the driver seat. In one example, the driver moves his head in a range between 5 cm to 20 cm in order to achieve the view to the rear.

Furthermore, it is preferably provided, when the vehicle rearview mirror is moved from the current adjustment position back into the base position for the case that in the second method step, it is established that a foreign vehicle is no longer located in the predetermined dazzle area. This reset of the vehicle rearview mirror into the base position can take place as quickly as possible or with a time delay or at various speeds.

One advantage of the fastest possible reset is that the familiar view of the driver of the ego vehicle to the rear is ensured again as quickly as possible by the vehicle rearview mirror located in its base position.

The advantage of a time delay during the reset is that in particular during journeys with changing or high traffic volume, vehicles move into the dazzle area and/or out of the dazzle area again and again and therefore a repeating change of the positioning of the vehicle rearview mirror of the ego vehicle between the base position and various adjustment positions can be avoided.

One advantage of a reset at a moderate speed is that in particular sensitive drivers could perceive a change of the alignment of the vehicle rearview mirror which is too fast as disturbing, even if the vehicle rearview mirror is only arranged at the edge of the field of view of the driver.

It has proven to be advantageous for the surroundings of the ego vehicle to be a circular registration area having a first center point M₁ and a first radius r₁, wherein the first center point Mi is located in the ego vehicle and wherein the first radius r₁ comprises 200 m, 150 m, 100 m, or 75 m.

An area in which the surroundings of the ego vehicle are registered in the first method step is a spatially bounded area which is referred to hereinafter as the registration area. In one embodiment, this registration area corresponds to a circular area having a first radius r₁, in the first center point M₁ of which the ego vehicle is located. A first radius r₁ around the ego vehicle is, for example, 200 m. In an alternative embodiment, the first radius r₁ is 150 m, 100 m, or 75 m. The location of the first center point M₁ corresponds, for example, to a geometrical center point of the ego vehicle or a center of gravity of the ego vehicle.

Within this defined registration area, foreign vehicles are registered with their positions and stored for the further method sequence. For this purpose, at least one central control unit is provided in the ego vehicle, which is connected to the sensors required for the registration and which controls sequences such as the method according to the disclosure. In addition, such a central control unit also controls other assistance systems of the motor vehicle, for example, for avoiding collisions or for adapting the speed of the motor vehicle to a current traffic situation.

It has proven to be particularly advantageous if the predetermined dazzle area corresponds to a circular sector having a second center point M₂, a center point angle α, which is also referred to as an opening angle, and a second radius r₂, wherein the center point angle α is in a range between 150° and 180°, in particular is 165°, wherein the second radius r₂ is in a range between 50 m and 200 m, in particular is 100 m, and wherein the circular sector is oriented to the rear essentially counter to a travel direction of the ego vehicle.

Since not all foreign vehicles detected in the first method step in the registration area can cause dazzling of the driver of the ego vehicle, a dazzle area is predetermined. In general, it is assumed that foreign vehicles which are located to the rear and partially laterally to the ego vehicle can potentially dazzle the driver of the ego vehicle.

This dazzle area is advantageously a circular sector having a second center point M₂, a center point angle α, and a second radius r₂. The location of the second center point M₂ preferably corresponds with the location of the first center point M₁, for example, in the geometrical center point of the ego vehicle. The second radius r₂ corresponds to the first radius r₁ or is selected to be smaller than this first radius. The second radius r₂ can be changed in the method sequence. For example, the second radius r₂ is equal to the first radius r₁ in poor visibility conditions, for example at night, while the second radius r₂ corresponds to half of the first radius r₁ in good visibility conditions during the day. The center point angle α can also be changed in the method sequence. In this way, an adaptation can take place to various conditions such as day, night, or weather and to various drivers of the ego vehicle.

The center point angle α is preferably aligned such that an angle bisector of the center point angle α is arranged aligned on a longitudinal axis of the ego vehicle, wherein the center point angle α and therefore the circular sector is aligned to the rear essentially opposite to the travel direction of the ego vehicle.

For example, the changeable center point angle α is in a range between 150° and 180°. The center point angle α is preferably 165°. The second changeable radius r₂ is, for example, in a range between 50 m and 200 m. The second radius r₂ is preferably 100 m. An optimum registration of foreign vehicles which can potentially dazzle the driver of the ego vehicle is achieved by the selection of such values for the center point angle α and the second radius r₂.

Furthermore, it is preferred if the position of a foreign vehicle located in the surroundings of the ego vehicle is determined by means of at least one sensor, wherein a sensor is a camera, a radar, a laser (LiDAR), an ultrasonic sensor (USS), or a combination thereof.

Within the defined registration area, in the first method step, foreign vehicles are captured with their positions and stored for the further method sequence. For this purpose, for example, cameras arranged in the motor vehicle in any case can be used as the sensor. Alternatively or additionally, technologies such as radar or laser are used as the sensor. Lasers are also referred to in automotive engineering as LiDAR, which means “light detection and ranging”. Furthermore, the use of ultrasound as the sensor is also provided. Ultrasound is also referred to in automotive engineering as USS, which means “ultrasonic sensor”. It is provided in particular that several of these sensors or technologies are used jointly to register the positions of the foreign vehicles.

It is advantageous if the position of the head of the driver in the ego vehicle is registered by means of an interior camera of the ego vehicle.

An interior camera is arranged in the ego vehicle. This interior camera can be oriented in particular on the area of the driver seat. In this way, it is possible to register a position of the driver, a position of the head of the driver, and also gestures of the driver of the ego vehicle by means of the interior camera and corresponding image evaluation software. Gestures of the driver can be, for example, movements of the head of the driver or movements of the eyelids of the driver. For example, dazzling of the driver of the ego vehicle by a foreign vehicle can be concluded from a head movement of the driver to the side or rotation of the head of the driver and from movements of the eyelids of the driver to close the eyes, in conjunction with other information present in the method. The current position of the head of the driver is preferably registered in order to check in said fourth method step whether a light beam of a light source of the foreign vehicle located in the dazzle area, reflected via the mirror glass of the vehicle rearview mirror, can reach the driver of the ego vehicle and dazzle him.

It is also preferable if the current setting of the vehicle rearview mirror of the ego vehicle is registered by means of data of a mirror adjustment device and/or by means of sensors in the vehicle rearview mirrors.

For the initial check in said fourth method step as to whether a light beam of a light source of the foreign vehicle located in the dazzle area, reflected via the mirror glass of the vehicle rearview mirror, can dazzle the driver, it is preferred if data on the current setting of the vehicle rearview mirror were provided. In particular, these data could be determined or registered before the initial check.

In a variant for registering the current setting of the vehicle rearview mirror, it is preferably provided that values for the yaw angle and the angle of inclination are provided by the mirror adjustment device. Since the vehicle rearview mirrors arranged on the ego vehicle are preferably each individually brought into their respective so-called base position before beginning a journey by means of the mirror adjustment device, in which base position the vehicle rearview mirrors enable an optimum view to the rear for the driver, a value for the yaw angle and the angle of inclination of the mirror glass in the vehicle rearview mirror can also be provided by means of a correspondingly equipped mirror adjustment device.

In an alternative variant for registering the current setting of the vehicle rearview mirror of the ego vehicle, it is provided that values for the yaw angle and angle of inclination are provided by angle sensors, which are integrated into the vehicle rearview mirrors and can supply the corresponding data in this way.

In both variants for registering the current setting of the vehicle rearview mirror, a connection to the central control unit can be provided in the ego vehicle, to transmit the data or measured values accordingly and provide these data for the performance of the present method in the central control unit.

In one preferred embodiment variant of the method, it is provided that the initial check as to whether the light beam of the light source of the foreign vehicle located in the dazzle area can dazzle the driver of the ego vehicle is carried out using data on the determined position of the foreign vehicle in the dazzle area, on the registered current setting of the vehicle rearview mirror of the ego vehicle, and on the registered position of the head of the driver in the ego vehicle.

In said fourth method step, the previously determined data listed above are used or processed in the performance of the initial check. In this initial check, it is checked whether a light beam originating from a headlight of a foreign vehicle which reaches the mirror glass in the vehicle rearview mirror will be reflected by the current setting of the mirror glass in the vehicle rearview mirror in the direction of the position of the head of the driver of the ego vehicle and can therefore dazzle the driver.

A first condition for the initial check is that the position of the foreign vehicle in the dazzle area is known. In a simple variant of the initial check, the starting point of the light beam is the position of the foreign vehicle in the dazzle area.

The positions of the headlights on the foreign vehicle are essentially also known with sufficient accuracy by way of the position of the foreign vehicle in the dazzle area. In an expanded variant of the initial check, the starting points of the light beams are the position of the headlights on the foreign vehicle in the dazzle area.

Based on an above-described starting point, for the light beam studied in the initial check, it is directed onto the vehicle rearview mirror to be observed. The light beam is preferably directed onto the geometrical center point of the mirror glass in the vehicle rearview mirror to be observed.

Since data on the current setting of the mirror glass in the vehicle rearview mirror are known in the form of values for the yaw angle and angle of inclination, it is determined according to the law of reflection in which direction the light beam incident on the mirror glass will be reflected. Under the presumption that the position of the vehicle rearview mirror on or in the ego vehicle is known and that the position of the head of the driver in the ego vehicle has been determined, it is determined in a dazzle check whether there is an intersection between the reflected light beam and the position or the area of the head of the driver in the ego vehicle.

If it is determined in this dazzle check that the head of the driver is located in the course of the reflected light beam, the present method presumes dazzling of the driver and carries out the above-described steps of changing the current setting of the vehicle rearview mirror to reduce the dazzling of the driver. Such a dazzle check can be restricted to the position of the eyes of the driver or can comprise at least a section of the head.

If it is determined in this dazzle check that the head of the driver is not located in the course of the reflected light beam, the present method presumes that no dazzling of the driver can take place. In this case, no change of the current setting of the vehicle rearview mirror will be performed. Alternatively, the vehicle rearview mirror is moved out of a current adjustment position back into the base position since dazzling can no longer take place.

It is additionally provided that furthermore the current light conditions and the intensity of the light beam of the light source of the foreign vehicle are determined for the initial check.

To improve the present method, a determination of the current light conditions is carried out. It is preferably taken into consideration that a reflected light beam of a headlight of a foreign vehicle reaching the driver via a vehicle rearview mirror in good weather with sunshine has significantly less dazzling effect on the driver of the ego vehicle than is the case in darkness or when driving through a tunnel. Therefore, sensors are preferably also used which register the current light conditions in the surroundings of the ego vehicle and provide the determined measured values to the present method.

Furthermore, it can also be established which intensity the light beam of the light source of the foreign vehicle has. Therefore, for example, no change of the current setting of the vehicle rearview mirror, in particular in said fifth method step, is carried out if the intensity of the light beam of the light source of the foreign vehicle is below a defined tolerance threshold. This prevents, for example, a change of the current setting of the vehicle rearview mirror from taking place if the light beam was only emitted from a daytime running light or a position light of the foreign vehicle in the dazzle area with low intensity or low energy. Sensors or methods such as a lux meter or a photometer having corresponding light-sensitive sensors can be used to measure the intensity or energy of the light beam of the light source.

Furthermore, it can additionally be provided that the change of the current setting of the vehicle rearview mirror takes place continuously or in adjustment steps, wherein an adjustment step has an angle amount of 0.3°, 0.5°, or 1.0°.

The change of the current setting of the vehicle rearview mirror can preferably take place continuously. In this case, the vehicle rearview mirror is moved back and forth, for example, between the base position defined by the driver and an adjustment position defined in the method.

For better adaptation of the method, it can also be provided that the current setting of the vehicle rearview mirror is changed in adjustment steps. Such adjustment steps have an angle amount which is 0.3°, 0.5°, or 1.0°. It is therefore possible to increase the current setting of the vehicle rearview mirror, for example, adjustment step by adjustment step in order to achieve the optimum setting of the vehicle rearview mirror to reduce the dazzling of the driver in this way. If, for example, adjustment steps having an angle amount of 0.5° each are used as the basis, a resulting angle amount after three successive adjustment steps is thus 1.5°. Such adjustment steps are used, in particular in the fifth method step, to reduce dazzling of the driver step by step.

For the case that a foreign vehicle is no longer detected in the second method step or that dazzling of the driver of the ego vehicle is no longer established in the fourth method step, the setting of the vehicle rearview mirror from its current adjustment position back into the base position can also take place in adjustment steps. Alternatively, the setting of the vehicle rearview mirror from its current adjustment position back into the base position can take place in a single step.

In one preferred design of the method, the vehicle rearview mirror can be a driver side rearview mirror or a passenger side rearview mirror or an interior vehicle rearview mirror of the ego vehicle.

The driver of the ego vehicle can be dazzled by one or more vehicle rearview mirrors. For this reason, the method for aligning a vehicle rearview mirror is preferably carried out for several of these vehicle rearview mirrors, in order to reduce the dazzling of the driver of the ego vehicle by changing the current settings of several vehicle rearview mirrors.

Therefore, for example, the initial check is optionally carried out such that during the check, the vehicle rearview mirror to be observed is the driver side rearview mirror and/or the passenger side rearview mirror. Furthermore, the vehicle rearview mirror to be observed in the initial check is optionally the interior vehicle rearview mirror.

It is preferred if the driver of the ego vehicle, upon a change of a current setting of a vehicle rearview mirror performed according to the method, receives information about this. The driver therefore knows that his head has to move accordingly to enable a view to the rear via the vehicle rearview mirror. For example, information about the performed change of the vehicle rearview mirror is output optically and/or acoustically to the driver via a suitable human-machine interface (HMI).

To improve the view to the rear, for the case that the ego vehicle is moved in reverse gear, it is provided that the vehicle rearview mirror is moved into its base position. Alternatively, the vehicle rearview mirror can be moved into a reverse driving position defined beforehand by the driver.

The device part of the object is achieved by an ego vehicle having a vehicle rearview mirror having the features of claim 14.

An ego vehicle is disclosed having a vehicle rearview mirror which is configured in particular to carry out the disclosed method comprising at least:
first sensors, designed to register the surroundings of the ego vehicle in order to determine positions of foreign vehicles located in the surroundings of the ego vehicle,
a central control unit, designed to ascertain whether a determined position of a foreign vehicle is in a predetermined dazzle area and to carry out an initial check as to whether a light beam of a light source of the foreign vehicle located in the dazzle area can dazzle the driver,
an interior camera, designed to register a position of the head of the driver in the ego vehicle,
further sensors, designed to register a current setting of the vehicle rearview mirror of the ego vehicle,
a mirror adjustment device, designed to change the current setting of the vehicle rearview mirror from the base position into an adjustment position deviating from the base position or from a current adjustment position into a further adjustment position to reduce the dazzling of the driver by the light beam of the foreign vehicle.

The advantages mentioned above with regard to the method are correspondingly associated with the ego vehicle. In particular, the ego vehicle according to one of the above-mentioned designs or a combination of at least two of these designs with one another can be used to carry out the method.

At least one vehicle rearview mirror is arranged on an ego vehicle. Preferably, multiple vehicle rearview mirrors are arranged on an ego vehicle, wherein vehicle rearview mirrors can be a driver side rearview mirror and a passenger side rearview mirror and an interior vehicle rearview mirror of the ego vehicle.

The ego vehicle having its vehicle rearview mirrors has first sensors to carry out the method for aligning a vehicle rearview mirror to reduce dazzling of a driver of an ego vehicle. The surroundings of the ego vehicle are registered by means of these first sensors.

Furthermore, the ego vehicle has a central control unit. By means of this central control unit, the data of the first sensors are evaluated to determine positions of foreign vehicles located in the surroundings of the ego vehicle and store them for the further method sequence. Furthermore, the central control unit ascertains whether a determined position of a foreign vehicle is located in a predetermined dazzle area. In addition, the central control unit is also used to carry out an initial check of whether a light beam of a light source of the foreign vehicle located in the dazzle area can dazzle the driver of the ego vehicle.

The ego vehicle furthermore comprises an interior camera, by means of which a position of the head of the driver in the ego vehicle is registered. The interior camera is connected to the central control unit for the transmission of its data.

A current setting of the vehicle rearview mirror or multiple vehicle rearview mirrors of the ego vehicle is registered by means of further sensors arranged in the ego vehicle.

The vehicle rearview mirrors of the ego vehicle each have an associated mirror adjustment device, which is designed in each case to change the current setting of the vehicle rearview mirror from the base position into an adjustment position deviating from the base position or from a current adjustment position into a further adjustment position. The goal of this change of the current setting of the vehicle rearview mirror is a reduction of the dazzling of the driver by the light beam of the foreign vehicle.

It is provided according to the disclosure that first sensors are a camera, a radar, a laser (LiDAR), or an ultrasonic sensor (USS). Such first sensors known from the prior art are used individually or in a combination of at least two such sensors to register the surroundings of the ego vehicle in order to detect foreign vehicles located in the surroundings of the ego vehicle.

Furthermore, it is also provided according to the disclosure that the central control unit is a vehicle control unit. Such a central control unit is, for example, a vehicle control unit, which is also referred to as an ECU (electronic control unit).

It has proven to be advantageous for further sensors to be angle sensors. Such angle sensors are arranged in the vehicle rearview mirrors of the ego vehicle and ascertain the yaw angle and the angle of inclination of the mirror glass in the respective vehicle rearview mirror. The ascertained angle values of the yaw angle and the angle of inclination are transmitted to the central control unit and processed by the central control unit during the performance of the method to align a vehicle rearview mirror.

### BRIEF DESCRIPTION OF THE DRAWINGS

Further advantageous configurations of the disclosure are disclosed in the dependent claims and in the following description of the figures. In the figures:

FIG. 1 shows an ego vehicle having a driver in a traffic situation with multiple foreign vehicles,

FIG. 2 shows a view of an ego vehicle with vehicle rearview mirrors from above,

FIG. 3 shows a view of an ego vehicle with vehicle rearview mirrors from a driver side,

FIG. 4 shows an exemplary flow chart of a method according to the disclosure,

FIGS. 5a and 5b show a change of the current setting of the vehicle rearview mirror on the basis of the example of a change of the yaw angle of a vehicle rearview mirror,

FIGS. 6a and 6b show a driving situation in which a change of the angle of inclination of the vehicle rearview mirror takes place, and

FIGS. 7a and 7b show a driving situation in which a change of the yaw angle of the vehicle rearview mirror takes place.

### DETAILED DESCRIPTION

In the different figures, identical parts are always provided with the same reference signs, for which reason these parts are generally also described only once.

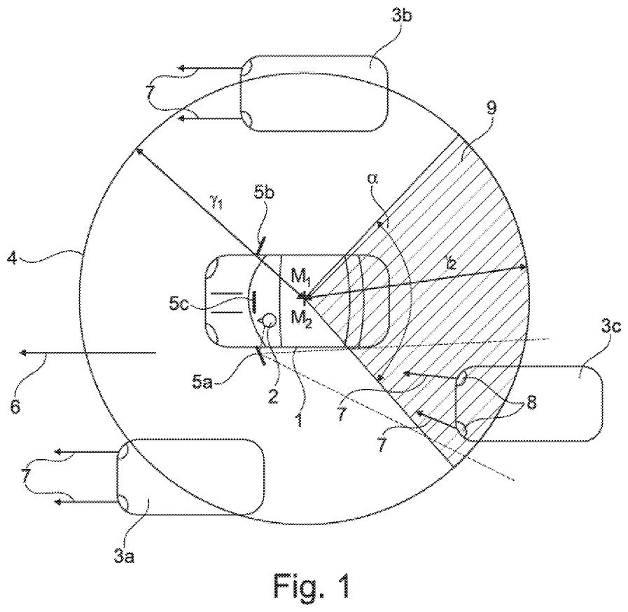

FIG. 1 shows an ego vehicle 1 having a driver 2 in a traffic situation with multiple foreign vehicles 3.

The ego vehicle 1 is shown in a view from above in a traffic situation on a multilane roadway, for example. The ego vehicle 1 as an ego motor vehicle has surroundings or a circular registration area 4 having a first center point M₁ and a first radius r₁, wherein the first center point M₁ is in the area of the ego vehicle 1. In the example of FIG. 1, the first center point M₁ is located in a geometric center point of the ego vehicle 1.

In a first step, positions of foreign vehicles 3 located in the registration area 4 are determined and stored. In the example of FIG. 1, the registration area 4 is circular, wherein three foreign vehicles 3a, 3b, and 3c, which are at least partially located in the registration area 4, are detected. Sensors or systems using cameras, radar, laser (LiDAR), ultrasound (USS) or combinations of these systems are used for this purpose.

Vehicle rearview mirrors are arranged on the ego vehicle 1. In the example of FIG. 1, a driver side rearview mirror 5a is arranged on a driver side and a passenger side rearview mirror 5b is arranged on a passenger side on the ego vehicle 1. Furthermore, an interior vehicle rearview mirror 5c is arranged in the interior of the ego vehicle 1.

For example, in FIG. 1, a view of the driver 2 to the rear by way of the driver side rearview mirror 5a, opposite to a travel direction 6 of the ego vehicle 1, is represented by means of dot-dot lines. In a view into the driver side rearview mirror 5a, the driver 2 sees, for example, the foreign vehicle 3c located in an area between the dot-dot lines. For the case that the foreign vehicle 3c generates a light beam 7, for example, by means of a light source 8 such as a headlight, this light beam 7, reflected in a mirror glass (not shown) in the driver side rearview mirror 5a, can reach and dazzle the driver 2 of the ego vehicle 1.

A so-called dazzle area 9 is advantageously defined and it is ascertained whether a determined position of a foreign vehicle 3 or a foreign vehicle 3 is located within this predetermined dazzle area 9. In the example in FIG. 1, the dazzle area 9 is in the form of a circular sector and is shown identified by means of shading. The dazzle area 9 is a circular sector having a second center point M₂, a center point angle α, also referred to as an opening angle, and a second radius r₂. In the example, the second center point M₂ is likewise in the geometric center point of the ego vehicle 1 and therefore corresponds to the location of the first center point M₁.

Upon the ascertainment, it is established in a second method step on the basis of the example of FIG. 1 that only the foreign vehicle 3c is at least partially located in the dazzle area 9. The foreign vehicles 3a and 3b are located inside the registration area 4 but not in the dazzle area 9 in the form of a circular sector, which is aligned toward the rear opposite to the travel direction 6 of the ego vehicle 1. It is presumed here that a light beam 7 of the foreign vehicle 3c could potentially dazzle the driver 2 by a reflection, in particular in the driver side rearview mirror 5a. To avoid or reduce such dazzling, a change of the current setting of the driver side rearview mirror 5a on the ego vehicle 1 is performed. Possible dazzling of the driver 2 by reflection in the passenger side rearview mirror 5b and in the interior vehicle rearview mirror 5c are also taken into consideration here, which is not shown in FIG. 1.

In particular, it is furthermore presumed that a light beam 7 of the foreign vehicle 3a or 3b cannot dazzle the driver 2 by a reflection in one of the vehicle rearview mirrors 5a, 5b, or 5c, since the foreign vehicles 3a and 3b are not currently located in the defined dazzle area 9.

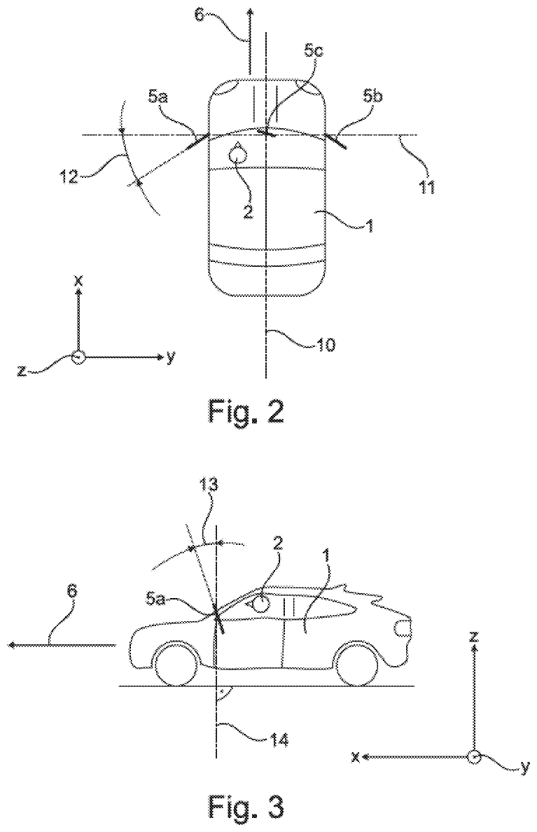

FIG. 2 shows a view of the ego vehicle 1 having the vehicle rearview mirrors 5a, 5b, and 5c from above.

The ego vehicle 1 has a longitudinal axis 10 extending in an X direction, wherein the X direction extends in the travel direction 6 of the ego vehicle 1. Furthermore, the ego vehicle 1 has a transverse axis 11 extending in a Y direction, wherein the transverse axis 11 of the ego vehicle 1 is arranged orthogonally to the longitudinal axis 10 of the ego vehicle 1.

The alignment or current setting of the mirror glass (not shown) in the respective vehicle rearview mirror 5a, 5b, 5c is described by means of two angles or two angle values. A first angle is a yaw angle 12, which specifies a deviation of the alignment of the mirror glass in the vehicle rearview mirror 5a, 5b, 5c from the transverse axis 11 of the ego vehicle 1.

This is shown by way of example in FIG. 2 for the driver side rearview mirror 5a. Between the transverse axis 11 of the ego vehicle 1 and the current alignment of the mirror glass in the driver side rearview mirror 5a, the yaw angle 12 results, which is set by the driver 2 before beginning a journey, for example, such that the driver 2 obtains an optimum view to the rear by way of the driver side rearview mirror 5a located in the base position, in order to be able to monitor the traffic events to the rear and partially adjacent to the ego vehicle 1. The yaw angle 12 therefore specifies a deviation of the alignment of the mirror glass in the vehicle rearview mirror 5a from the transverse axis 11 of the ego vehicle 1.

FIG. 3 shows a view of an ego vehicle 1 with vehicle rearview mirror from a driver side. The ego vehicle 1, which is preferably moving in an X direction or the travel direction 6, is shown on a roadway.

The ego vehicle 1 extends in a Z direction in its height. A second angle, which is referred to as the angle of inclination 13, is described with its angle value on the basis of the example of the driver side rearview mirror 5a. This angle of inclination 13 results between the current alignment of the mirror glass in the driver side rearview mirror 5a and a vertical line 14. This vertical line 14 extends in the Z direction and intersects a plane on which the motor vehicle 1 is located, such as a roadway, at a right angle, as shown in FIG. 3. The angle of inclination 13 therefore specifies a deviation of the alignment of the mirror glass in the vehicle rearview mirror 5a from the vertical line 14.

The angle of inclination 13 is set by the driver 2 before beginning a journey, for example, such that the driver 2 obtains an optimum view to the rear by way of the driver side rearview mirror 5a located in the base position in order to be able to monitor the traffic events to the rear and partially adjacent to the ego vehicle 1.

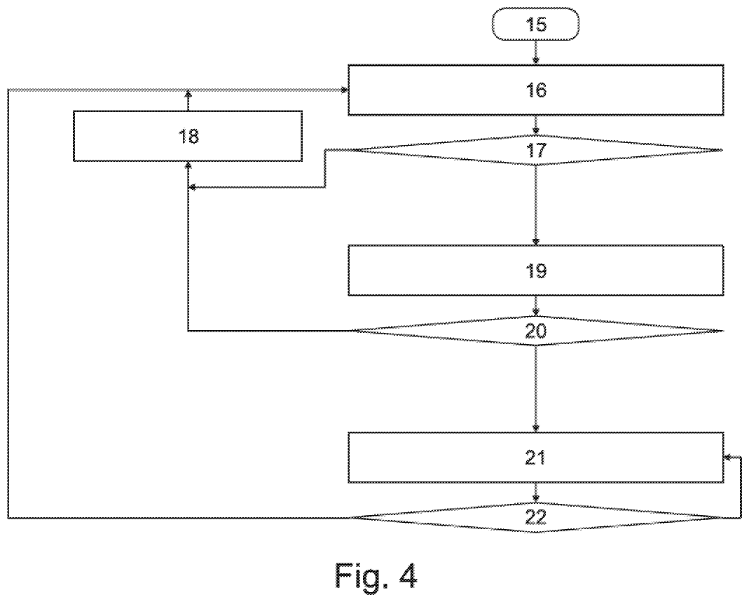

FIG. 4 shows an exemplary flow chart of the method according to the disclosure.

After a start of the method for aligning a vehicle rearview mirror 5a, 5b, 5c to reduce dazzling of a driver 2 of an ego vehicle 1 in a starting step 15, in a first method step 16, the surroundings or a registration area 4 of the ego vehicle 1 are registered. In this case, positions of foreign vehicles 3 located in the registration area 4 of the ego vehicle 1 are determined. In this case, for example, three foreign vehicles 3a, 3b, 3c in the registration area 4, which is circular, for example, are registered and their positions are stored.

In a following second method step 17, it is determined whether a position of a foreign vehicle 3a, 3b, 3c determined in first method step 16 is located in a predetermined dazzle area 9, which is in the form of a circular sector, for example.

For the case that it is established in second method step 17 that no foreign vehicle 3a, 3b, 3c is currently located in the dazzle area 9, it is provided that the method returns to first method step 16 via reset step 18. For the case that the vehicle rearview mirror 5a, 5b, 5c is in its base position, the vehicle rearview mirror 5a, 5b, 5c remains in reset step 18 in the base position set at the beginning of the journey. For the case that the setting of the vehicle rearview mirror 5a, 5b, 5c was already previously changed from its base position into an adjustment position, in reset step 18, the vehicle rearview mirror 5a, 5b, 5c is caused to move back from the current adjustment position into the base position again.

For the case that it is established in second method step 17 that at least one foreign vehicle 3a, 3b, 3c is currently located in the dazzle area 9, it is provided that the method is continued with a third method step 19. In this third method step 19, a current position of the head of the driver 2 in the ego vehicle 1 is determined. This is advantageous since not all drivers 2 of an ego vehicle 1 have a comparable anatomy and/or perform different settings, for example, of the height and/or the inclination of a vehicle seat in the motor vehicle 1.

Furthermore, the current setting of the vehicle rearview mirror 5a, 5b, 5c, in particular of the mirror glass in the vehicle rearview mirror 5a, 5b, 5c, is registered. In this case, in particular values for the yaw angle 12 and angle of inclination 13 of the mirror glass of the vehicle rearview mirror 5a, 5b, 5c are registered to prepare for following fourth method step 20. At the end of third method step 19, for example, information on a position of a foreign vehicle 3 in the dazzle area 9, a position of the head of the driver 2 in the ego vehicle 1, and on the current setting of the vehicle rearview mirror 5a, 5b, 5c are known with associated yaw angle 12 with respect to a transverse axis 11 and angle of inclination 13 with respect to a vertical line 14.

In fourth method step 20, an initial check takes place such that it is established whether a light beam 7 of a light source 8 of the foreign vehicle 3 located in the dazzle area 9 can dazzle the driver 2 of the ego vehicle 1.

In a preferred method sequence, it can also be provided that multiple foreign vehicles 3a, 3b, 3c are observed, which each have multiple light sources 8. Therefore, multiple corresponding first checks are optionally performed in fourth method step 20 in order to check whether one of the multiple light beams 7 of the multiple light sources 8 of the foreign vehicles 3a, 3b, 3c located in the dazzle area 9 can dazzle the driver.

If it is established in this initial check in fourth method step 20 that dazzling of the driver 2 of the ego vehicle 1 is not probable and the vehicle rearview mirror 5a, 5b, 5c, in particular the mirror glass in the vehicle rearview mirror 5a, 5b, 5c, is in the base position, no change of the current setting of the vehicle rearview mirror 5a, 5b, 5c is performed in reset step 18. The method is then continued in first method step 16.

For the alternative case that it is established in this initial check in fourth method step 20 that dazzling of the driver 2 of the ego vehicle 1 is not probable and the vehicle rearview mirror 5a, 5b, 5c, in particular the mirror glass in the vehicle rearview mirror 5a, 5b, 5c is already in an adjustment position, the vehicle rearview mirror 5a, 5b, 5c is transferred in reset step 18 from this adjustment position back into its base position again. The method is then continued in first method step 16.

In contrast, if it is established in the initial check that dazzling of the driver 2 of the ego vehicle 1 is probable, in a following fifth method step 21, a change of the current setting of the vehicle rearview mirror 5a, 5b, 5c, in particular the mirror glass in the vehicle rearview mirror 5a, 5b, 5c, is performed. Such a change of the current setting of the vehicle rearview mirror 5a, 5b, 5c can be an adjustment from the base position into an adjustment position or an adjustment from a current first adjustment position into a further second adjustment position. Such a change of the current setting of the vehicle rearview mirror 5a, 5b, 5c can relate here to the yaw angle 12 of the mirror glass or the angle of inclination 13 of the mirror glass or the yaw angle 12 and angle of inclination 13.

After a change of the current setting of the vehicle rearview mirror 5a, 5b, 5c in fifth method step 21, the method is continued in a base variant in first method step 16 with a further pass, which is not shown in FIG. 4.

FIG. 4 shows an additional method step 22 optionally following fifth method step 21. In this additional method step 22, a second check takes place such that it is determined whether the driver 2 of the ego vehicle 1 is currently still being dazzled by the light beam 7 of the foreign vehicle 3, although a first change of the current setting of the vehicle rearview mirror 5a, 5b, 5c was already performed in fifth method step 21. For the case that the dazzling still exists, a further second change of the current setting of the vehicle rearview mirror 5a, 5b, 5c is performed, wherein the vehicle rearview mirror 5a, 5b, 5c is adjusted from its current adjustment position into a further adjustment position having a greater deviation from the base position. This further change of the current setting of the vehicle rearview mirror 5a, 5b, 5c takes place step by step until in the second check in fifth method step 21, current dazzling is no longer established.

For the case that a single adjustment step of the mirror glass in the vehicle rearview mirror 5a, 5b, 5c by a defined angle amount is not sufficient to sufficiently reduce the dazzling of the driver 2 by the light beam 7 of the foreign vehicle 3, the method runs through additional method step 22 and fifth method step 21 repeatedly before the method is continued in first method step 16. In this way, multiple adjustment steps are carried out in succession until the driver 2 is no longer dazzled or is no longer significantly dazzled by the light beam 7 of the foreign vehicle 3. After two or more such adjustment steps, in which an adjustment by the defined angle amount always takes place, the method is continued in first method step 16 with the next pass.

Such adjustment steps can change, for example, the yaw angle 12 and/or the angle of inclination 13 by an angle amount of 0.5° or 1.0°. In an example in which an adjustment step for the yaw angle 12 has an angle amount of 0.5° in each case, a resulting angle amount of the yaw angle 12 after three successive adjustment steps is 1.5° in order to effectively reduce the dazzling of the driver 2 by the light beam 7 of the foreign vehicle 3.

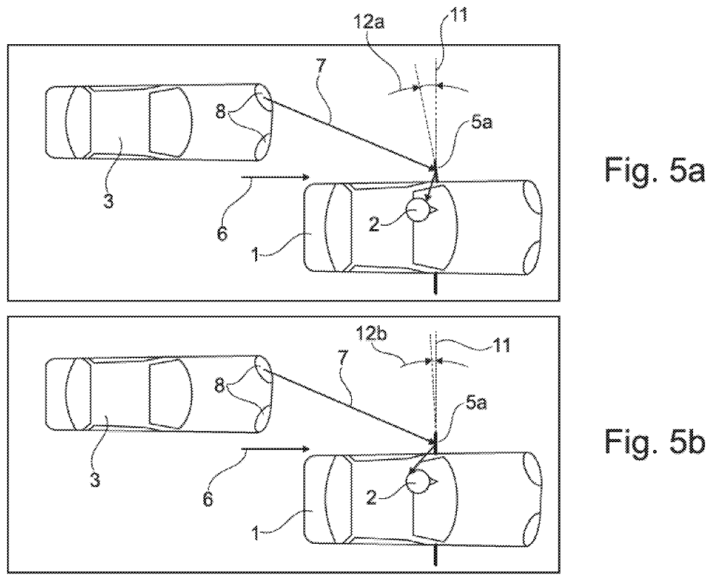

FIGS. 5a and 5b show a change according to the method of the current setting of the vehicle rearview mirror 5a on the basis of the example of a change of the yaw angle 12.

FIGS. 5a and 5b each show an ego vehicle 1 having a driver 2 and a driver side rearview mirror 5a. Furthermore, FIGS. 5a and 5b each show a foreign vehicle 3, which is located in the dazzle area 9. As an example, FIGS. 5a and 5b each show a light beam 7 emitted by a light source 8 of the foreign vehicle 3, which strikes the mirror glass arranged in the vehicle rearview mirror 5a.

It can be seen in FIG. 5a that the light beam 7 is reflected in the mirror glass of the driver side rearview mirror 5a. The driver side rearview mirror 5a with its mirror glass is in the base position and has a yaw angle 12a. The light beam 7 is reflected in the direction of the head of the driver 2, in particular in the area of the eyes of the driver 2 by the mirror glass set in this way in the driver side rearview mirror 5a, due to which the driver 2 in the ego vehicle 1 is dazzled.

The disclosure addresses this. It creates a reduction of the dazzling of the driver 2 of the ego vehicle 1 using the method according to the disclosure, which is shown in FIG. 5b. The foreign vehicle 3 in the dazzle area 9 was detected by the method and a change of the current setting of the driver side rearview mirror 5a from the base position into an adjustment position deviating from the base position was performed. In this adjustment position, the mirror glass of the driver side rearview mirror 5a has a yaw angle 12b, which is smaller than the yaw angle 12a.

This smaller yaw angle 12b results in a reflection of the light beam 7 in the mirror glass of the vehicle rearview mirror 5a such that the light beam 7 is no longer reflected in the direction of the head of the driver 2. The driver 2 of the ego vehicle 1 is therefore no longer dazzled. For the case that the driver 2 requires a view to the rear in spite of the driver side rearview mirror 5a located in the adjustment position, it is necessary for the driver 2 to change the position of his head in a reasonable range. Such a change of the position of the head of the driver 2 is, in the example of FIG. 5b, a movement of the head to the rear, wherein the driver 2 essentially maintains his position in the driver seat. This movement of the head of the driver 2 is not shown in FIG. 5b.

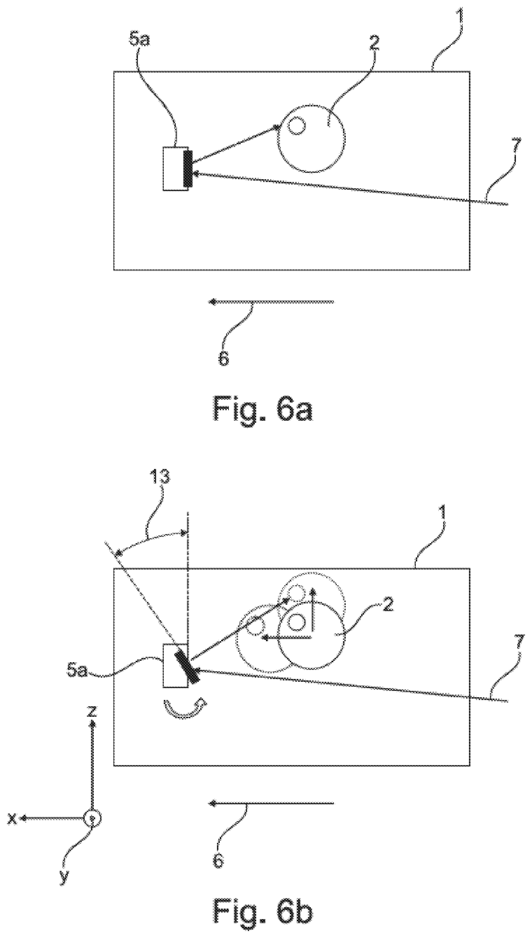

FIGS. 6a and 6b show a driving situation in which a change of the angle of inclination 13 of the driver side rearview mirror 5a takes place. FIGS. 6a and 6b each show an ego vehicle 1, which is only schematically shown, as well as a driver 2 and a driver side rearview mirror 5a. Furthermore, the travel direction 6 is shown, in which the ego vehicle 1 preferably moves.

A rectangular pivotable mirror glass can be seen in the driver side rearview mirror 5a, which is in the base position in FIG. 6a, which is also referred to in this description as the base position of the driver side rearview mirror 5a. A light beam 7 which is incident on the driver side rearview mirror 5a is reflected by the base position of the driver side rearview mirror 5a in FIG. 6a toward the driver 2 and perceived as disturbing.

In FIG. 6b, the mirror glass in the driver side rearview mirror 5a is pivoted away forward counterclockwise around a Y direction of the ego vehicle 1. The mirror glass in the driver side rearview mirror 5a has therefore been transferred into an adjustment position by adjustment according to the method with a changed angle of inclination 13, by which dazzling of the driver 2 of the ego vehicle 1 is reduced. This pivoting away around the Y direction is indicated in FIG. 6b by means of an arrow that can be seen adjacent to the driver side rearview mirror 5a.

A light beam 7 which is incident on the driver side rearview mirror 5a is reflected by the adjustment position of the driver side rearview mirror 5a in FIG. 6b into an area above the driver 2 and is therefore no longer perceived as disturbing. If the driver 2 of the ego vehicle 1 nonetheless wishes to achieve a view to the rear in this adjustment position of the vehicle rearview mirror 5a, he can move his head forward, thus in the travel direction, and/or upward in order to compensate for the adjustment procedure performed on the driver side rearview mirror 5a. This movement of the head forward or upward is shown in FIG. 6b by means of two arrows and the positions of the head of the driver 2 which can then be reached.

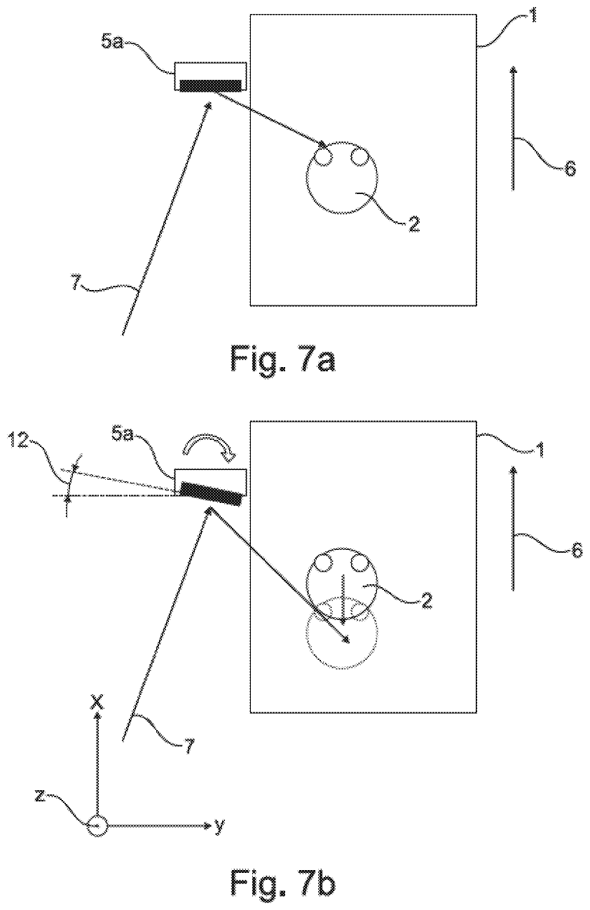

FIGS. 7a and 7b show a driving situation in which a change of the yaw angle 12 of the driver side rearview mirror 5a takes place. FIGS. 7a and 7b each show an ego vehicle 1, which is only schematically shown, as well as a driver 2 and a driver side rearview mirror 5a. Furthermore, the travel direction 6 is shown, in which the ego vehicle 1 preferably moves.

A rectangular pivotable mirror glass can be seen in the driver side rearview mirror 5a, which is in the base position in FIG. 7a, which is also referred to in this description as the base position of the driver side rearview mirror 5a. A light beam 7 which is incident on the driver side rearview mirror 5a is reflected by the base position of the driver side rearview mirror 5a in FIG. 7a toward the driver 2 and perceived as disturbing.

In FIG. 7b, the mirror glass in the driver side rearview mirror 5a is pivoted away outward clockwise around a Z direction of the ego vehicle 1. The mirror glass in the driver side rearview mirror 5a has therefore been transferred according to the method by adjustment with a changed yaw angle 12 into an adjustment position, by which dazzling of the driver 2 of the ego vehicle 1 is reduced. This pivoting away around the Z direction is indicated in Figure b by means of an arrow that can be seen above the driver side rearview mirror 5a.

A light beam 7 which is incident on the driver side rearview mirror 5a is reflected by the adjustment position of the driver side rearview mirror 5a in FIG. 7b into an area behind the driver 2 and is therefore no longer perceived as disturbing. If the driver 2 of the ego vehicle 1 nonetheless wishes to achieve a view to the rear in this adjustment position of the vehicle rearview mirror 5a, he can move his head to the rear, thus opposite to the travel direction, in order to compensate for the adjustment procedure performed on the driver side rearview mirror 5a. This movement of the head to the rear is shown in FIG. 7b by means of an arrow and the positions of the head of the driver 2 which can then be reached.

1. A method for aligning a vehicle rearview mirror to reduce dazzling of a driver of an ego vehicle, wherein the vehicle rearview mirror of the ego vehicle is aligned at the beginning of a journey in a base position, the method comprising:
registering surroundings of the ego vehicle, wherein the positions of foreign vehicles located in the surroundings of the ego vehicle are identified;
ascertaining whether a determined position of a foreign vehicle is located within a predetermined dazzle area;
registering a position of a head of the driver in the ego vehicle and a current setting of the vehicle rearview mirror of the ego vehicle;
determining whether a light beam of a light source of the foreign vehicle located in the predetermined dazzle area is dazzling the driver; and
changing the current setting of the vehicle rearview mirror from the base position to an adjustment position, or from a current adjustment position to a further adjustment position, to reduce dazzling of the driver.

2. The method according to claim 1, wherein the vehicle rearview mirror is moved from the current adjustment position back into the base position for the case it is established that a foreign vehicle is no longer located in the predetermined dazzle area.

3. The method according to claim 1, wherein the surroundings of the ego vehicle are a circular registration area having a first center point M1 and a first radius r1, wherein the center point M1 is located in the ego vehicle and wherein the radius r1 comprises one of 200 m, 150 m, 100 m, or 75 m.

4. The method according to claim 1, wherein the predetermined dazzle area corresponds to a circular sector having a second center point M2, a center point angle α, and a second radius r2, wherein the center point angle α is in a range between 150° and 180°, in particular is 165°, wherein the second radius r2 is in a range between 50 m and 200 m, and wherein the circular sector is aligned to the rear essentially opposite to a travel direction of the ego vehicle.

5. The method according to claim 1, wherein the position of a foreign vehicle located in the surroundings of the ego vehicle is determined based on data from at least one sensor, wherein a sensor comprises a camera, a radar, a laser (LiDAR), an ultrasonic sensor (USS), or a combination thereof.

6. The method according to claim 1, wherein the position of the head of the driver in the ego vehicle is registered based on data from an interior camera of the ego vehicle.

7. The method according to claim 1, wherein the current setting of the vehicle rearview mirror of the ego vehicle is registered based on one or more of (i) data from a mirror adjustment device or (ii) sensors in the vehicle rearview mirrors.

8. The method according to claim 1, wherein the first check as to whether the light beam of the light source of the foreign vehicle located in the dazzle area is dazzling the driver is carried out using data on the determined position of the foreign vehicle in the dazzle area, on the registered current setting of the vehicle rearview mirror of the ego vehicle, and on the registered position of the head of the driver in the ego vehicle.

9. The method according to claim 1, wherein for the first check the current light conditions and the intensity of the light beam of the light source of the foreign vehicle are ascertained.

10. The method according to claim 1, wherein a maximum resulting angle amount between the base position of the vehicle rearview mirror and a maximum adjustment position of the vehicle rearview mirror is between 3° to 20°, wherein a view of the driver of the ego vehicle to the rear is ensured even in the maximum adjustment position of the vehicle rearview mirror.

11. The method according to claim 1, wherein the change of the current setting of the vehicle rearview mirror takes place continuously or in adjustment steps, wherein an adjustment step has an angle amount of 0.3°, 0.5°, or 1.0°.

12. The method according to claim 1, wherein the vehicle rearview mirror is a driver side rearview mirror or a passenger side rearview mirror or an interior vehicle rearview mirror of the ego vehicle.

13. The method according to claim 1, wherein after the change of the current setting of the vehicle rearview mirror, a second check takes place as to whether the driver is currently still being dazzled by the light beam of the foreign vehicle, and when the dazzling is determined to still exists, a further change of the current setting of the vehicle rearview mirror from the current adjustment position into a further adjustment position having a greater deviation from the base position takes place until current dazzling is no longer established in the second check.

14. A ego vehicle having a vehicle rearview mirror, comprising at least
first sensors designed to register the surroundings of the ego vehicle,
a central control unit designed to determine positions of foreign vehicles located in the surroundings of the ego vehicle, to ascertain whether a determined position of a foreign vehicle is located in a predetermined dazzle area and to carry out a first check as to whether a light beam of a light source of the foreign vehicle located in the dazzle area can dazzle the driver,
an interior camera, designed to register a position of the head of the driver in the ego vehicle,
further sensors, designed to register a current setting of the vehicle rearview mirror of the ego vehicle, and
a mirror adjustment device, designed to change the current setting of the vehicle rearview mirror from the base position into an adjustment position deviating from the base position or from a current adjustment position into a further adjustment position to reduce the dazzling of the driver by the light beam of the foreign vehicle.

15. The ego vehicle according to claim 14, wherein the first sensors are a camera, a radar, a laser (LiDAR), or an ultrasonic sensor (USS).

16. The ego vehicle according to claim 14, wherein the central control unit is a vehicle control unit.

17. The ego vehicle according to claim 14, wherein further sensors are angle sensors.
